(19) United States
(12) Patent Application Publication
(10) Pub. No.: US 2024/0130578 A1
(43) Pub. Date: Apr. 25, 2024

(54) TOILET SEAT

(71) Applicant: Jose Raul Ojeda Lopez, Glendale, AZ (US)

(72) Inventor: Jose Raul Ojeda Lopez, Glendale, AZ (US)

(21) Appl. No.: 17/973,346

(22) Filed: Oct. 24, 2022

(51) Int. Cl. A47K 13/10; A47K 13/12; B29C 45/00

(52) U.S. Cl. CPC A47K 13/105; A47K 13/12; B29C 45/0081; B29L 2031/7694

(57) ABSTRACT

An improved toilet seat including an integral finger tab formed unitarily along with the toilet seat as one unitary member, such that a person can manipulate the toilet seat from a closed horizontal position to an open vertical position and vice versa without having to contact the main area of the toilet seat that surrounds a toilet bowl.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever. 37 CFR 1.71(d).

### BACKGROUND OF THE INVENTION

### 1. Field of the Invention

This invention relates generally to toilet seats, and more specifically to toilet seats pivotally attached to a toilet bowl.

### 2. Description of the Related Art

Prior art toilet seats are usually manipulated by hand from a closed horizontal position to an open vertical position and vice versa. The problem is that proper hygiene is limited since most toilet seats acquire an amount of human waste and germs on their surfaces adjacent a toilet bowl which are then transferred to a person's hand when moving the seat. Some attempts to overcome this problem include mechanisms that are designed to provide a handle spaced from the seat and connected via a series of linkages. These are bulky, unsightly, and require a lot of assembly. Other attempts have been to provide a handle or tab adapted to be attached to the seat via screws, bolts, or clamps. These also require assembly and become loose over time creating problems.

Accordingly, the present invention overcomes the disadvantages associated with the prior art by providing a toilet seat including an integral finger tab formed unitarily along with the toilet seat as one unitary member, such that a person can manipulate the toilet seat from a closed horizontal position to an open vertical position and vice versa without the problems associated with the prior art.

### BRIEF SUMMARY OF THE INVENTION

In view of the foregoing disadvantages inherent in the known types of toilet seats or the like in the prior art, the present invention provides an improved toilet seat including an integral finger tab formed unitarily along with the toilet seat as one unitary member, such that a person can manipulate the toilet seat from a closed horizontal position to an open vertical position and vice versa without having to contact the main area of the toilet seat that surrounds a toilet bowl, with all the advantages of the prior art and none of the disadvantages.

There has thus been outlined, rather broadly, the more important features of the invention in order that the detailed description thereof that follows may be better understood and in order that the present contribution to the art may be better appreciated.

Numerous objects, features and advantages of the present invention will be readily apparent to those of ordinary skill in the art upon a reading of the following detailed description of presently preferred, but nonetheless illustrative, embodiments of the present invention when taken in conjunction with the accompanying drawings. The invention is capable of other embodiments and of being practiced and carried out in various ways. Also, it is to be understood that the phraseology and terminology employed herein are for the purpose of descriptions and should not be regarded as limiting.

### BRIEF DESCRIPTION OF THE DRAWINGS

The figures which accompany the written portion of this specification illustrate embodiments according to the teachings of the present invention.

FIG. 1 shows a top perspective view of the improved toilet seat in a closed configuration according to the preferred embodiment of the present invention.

FIG. 2 shows a top perspective view of the improved toilet seat in an open configuration according to the preferred embodiment of the present invention of FIG. 1.

FIG. 3 shows a bottom perspective view of the improved toilet seat in a closed configuration according to the preferred embodiment of the present invention of FIG. 1.

FIG. 4 shows a perspective view of the tab having a curved cross-section and a lip of the improved toilet seat according to the preferred embodiment of the present invention of FIG. 1.

FIG. 5 shows a perspective view of the tab having a curved cross-section and a plurality of serrations of the improved toilet seat according to the preferred embodiment of the present invention of FIG. 1.

The various embodiments of the present invention will hereinafter be described in conjunction with the appended drawings.

### DETAILED DESCRIPTION

The embodiments of the present disclosure described below are not intended to be exhaustive or to limit the disclosure to the precise forms disclosed in the following detailed description. Rather, the embodiments are chosen and described so that others skilled in the art may appreciate and understand the principles and practices of the present disclosure.

The following embodiments and the accompanying drawings, which are incorporated into and form part of this disclosure, illustrate embodiments of the invention and together with the description, serve to explain the principles of the invention. To the accomplishment of the foregoing and related ends, certain illustrative aspects of the invention are described herein in connection with the following description and the annexed drawings. These aspects are indicative, however, of but a few of the various ways in which the principles of the invention can be employed and the subject invention is intended to include all such aspects and their equivalents. Other advantages and novel features of the invention will become apparent from the following detailed description of the invention when considered in conjunction with the drawings.

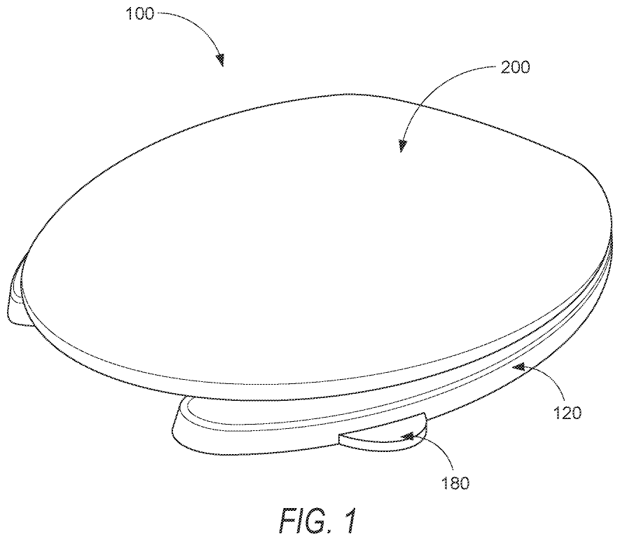

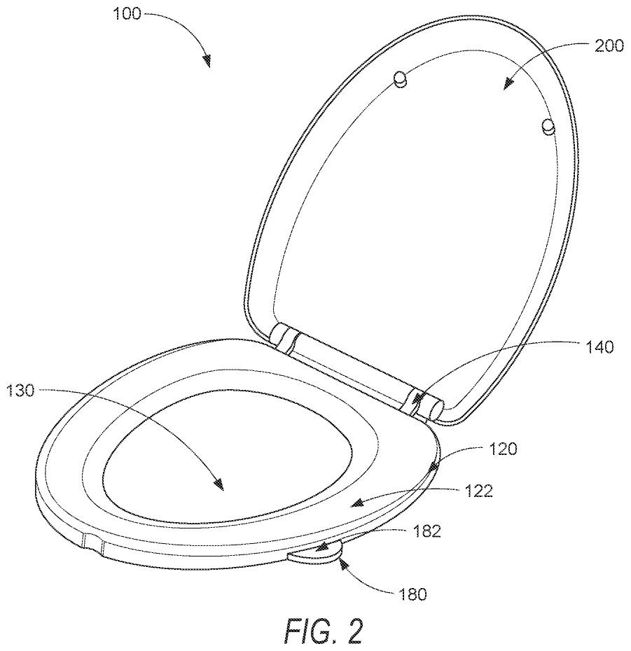

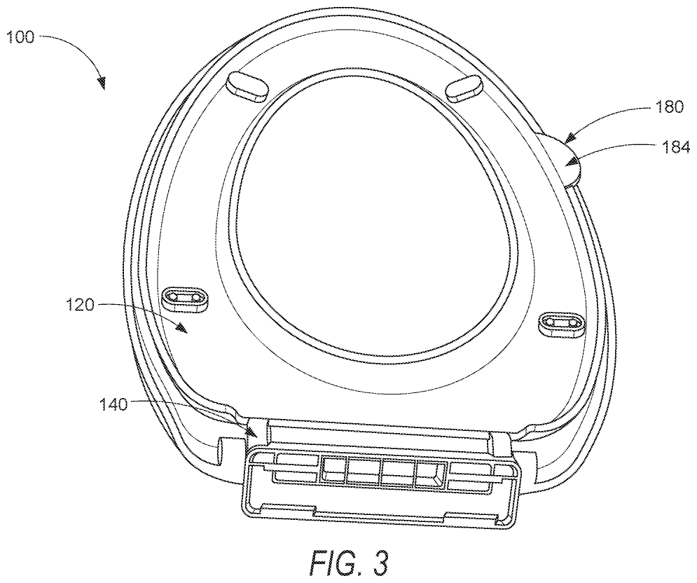

Turning now descriptively to drawing, referring to FIGS. 1-5, the present invention discloses an improved toilet seat 100 comprising a main body 120 including a top surface 122, a bottom surface, an outer edge including a front section a back section, and two opposite side portions respectively located between the front portion and the back portion, an opening 130 extending through the top surface and the bottom surface; a hinge 140 integrally formed with and extending from the back section, and wherein the hinge 140 is adapted to be releasably connected to a toilet bowl, such that the toilet seat is adapted to be pivotally connected to the toilet bowl; and a tab 180 integrally formed with and extending outwardly from one of the two opposite side portions, and is adapted to be engaged by a user to manipulate the main body 120 from a closed horizontal position to an open vertical position and vice versa without having to contact the top surface, the bottom surface, or the outer edge. The tab 180 includes a top surface 182, a bottom surface 184, an outer edge including a front section, a back section, and two opposite side portions respectively located between the front portion and the back portion, wherein the back section of the tab is integrally formed with one of the two opposite side portions of the main body 120, and wherein the top surface, the bottom surface, the front section, and the two opposite side portions of the tab are adapted to be engaged by a user to manipulate the main body from a closed horizontal position to an open vertical position and vice versa without having to contact the top surface, the bottom surface, or the outer edge.

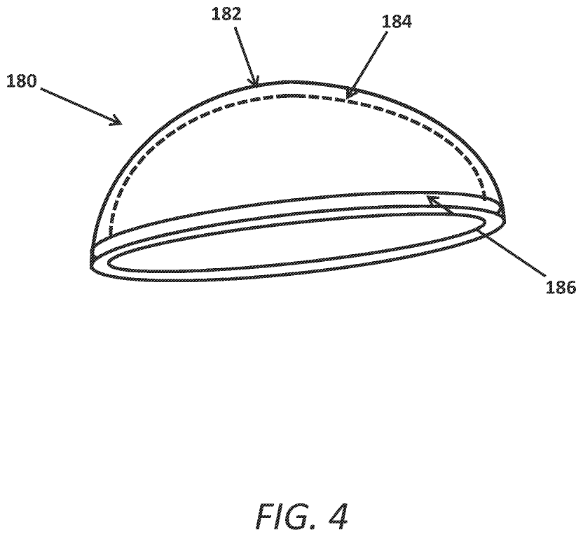

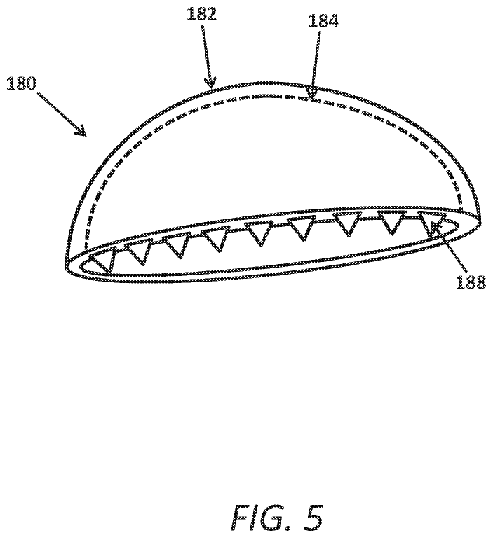

In order to increase friction between the tab 180 and a user and reduce the chance of the seat slipping from the user and slamming upon a toilet bowl, the top surface and the bottom surface of the tab 180 are formed having a curve cross-section, as shown in FIGS. 4 and 5. Further, the tab may include a lip 186, as shown in FIG. 4, extending downwardly from the front section and the two opposite side portions to increase friction between the tab and a user and reduce the chance of the seat slipping from the user and slamming upon a toilet bowl. Furthermore, the tab may include a plurality of spaced serrations 188, as shown in FIG. 5, extending downwardly the front section and the two opposite side portions adapted to increase friction between the tab and a user and reduce the chance of the seat slipping from the user and slamming upon a toilet bowl.

The main body and the opening of the toilet seat may be are formed having an oval shape, however other shapes, such as circular may be chosen and used.

The improved toilet further includes a cover 200 including a top surface, a bottom surface, an outer edge including a front section, a back section; and two opposite side portions respectively located between said front portion and said back portion, wherein the back section is pivotally connected to the back section of the outer edge of the main body via the hinge 140, and wherein the outer edge has a size and shape substantially equal to the outer edge of the main body, such that the cover is adapted to substantially and removably cover the top surface of the main body.

The method of making the improved toilet seat may vary, however in a preferred embodiment, the main body and cover are injection molded and then pivotally connected together. Another method of making that may be chosen is casting. The advantage of molding and casting is that the tab is integrally formed with the main body and therefore will never loosen. Furthermore, there is no need to buy extra equipment and avoid numerous installation steps. Even further, by integrally forming the tab with the main body of the toilet seat there are no spaces to accumulate germs and waste, thereby providing a more secure and sterile toilet environment.

Although specific embodiments have been illustrated and described herein, it will be appreciated by those of ordinary skill in the art that any arrangement, which is calculated to achieve the same purpose, may be substituted for the specific embodiment shown. This application is intended to cover any adaptations or variations of the present invention.

Although the invention has been explained in relation to its preferred embodiment, it is to be understood that many other possible modifications and variations can be made without departing from the spirit and scope of the invention.

What is claimed is:

1. An improved toilet seat comprising:
a main body including;
a top surface;
a bottom surface;
an outer edge including:
a front section;
a back section; and
two opposite side portions respectively located between said front portion and said back portion;
an opening;
wherein said opening extends through said top surface and said bottom surface;
a hinge;
wherein said hinge is integrally formed with and extends from said back section; and
wherein said hinge is adapted to be releasably connected to a toilet bowl, such that said toilet seat is adapted to be pivotally connected to said toilet bowl; and
a tab;
wherein said tab is integrally formed with and extends outwardly from one of said two opposite side portions, and is adapted to be engaged by a user to manipulate said main body from a closed horizontal position to an open vertical position and vice versa without having to contact said top surface, said bottom surface, or said outer edge.

2. The improved toilet seat of claim 1, wherein said tab includes:
a top surface;
a bottom surface;
an outer edge including:
a front section;
a back section; and
two opposite side portions respectively located between said front portion and said back portion;
wherein said back section of said tab is integrally formed with said one of said two opposite side portions; and
wherein said top surface, said bottom surface, said front section, and said two opposite side portions of said tab are adapted to be engaged by a user to manipulate said main body from a closed horizontal position to an open vertical position and vice versa without having to contact said top surface, said bottom surface, or said outer edge.

3. The improved toilet seat of claim 2, wherein said top surface and said bottom surface are formed having a curve cross-section adapted to increase friction between the tab and a user and reduce the chance of the seat slipping from the user and slamming upon a toilet bowl.

4. The improved toilet seat of claim 2, wherein said front section and said two opposite side portions of said tab include a lip extending downwardly therefrom adapted to increase friction between the tab and a user and reduce the chance of the seat slipping from the user and slamming upon a toilet bowl.

5. The improved toilet seat of claim 2, wherein said front section and said two opposite side portions of said tab include a plurality of spaced serrations extending downwardly therefrom adapted to increase friction between the tab and a user and reduce the chance of the seat slipping from the user and slamming upon a toilet bowl.

6. The improved toilet seat of claim 1, wherein said main body and said opening are formed having an oval shape.

7. The improved toilet seat of claim 1, further comprising:
a cover including:
a top surface;
a bottom surface;
an outer edge including:
a front section;
a back section; and
two opposite side portions respectively located between said front portion and said back portion;
wherein said back section is pivotally connected to said back section of said outer edge of said main body via said hinge; and
wherein said outer edge has a size and shape substantially equal to said outer edge of said main body, such that said cover is adapted to substantially and removably cover said top surface of said main body.

8. A method of making an improved toilet seat, comprising the steps of:
injection molding a main body including;
a top surface;
a bottom surface;
an outer edge including:
a front section;
a back section; and
two opposite side portions respectively located between said front portion and said back portion;
an opening;
wherein said opening extends through said top surface and said bottom surface;
a hinge;
wherein said hinge extends from said back section; and
wherein said hinge is adapted to be releasably connected to a toilet bowl, such that said toilet seat is adapted to be pivotally connected to said toilet bowl; and
a tab;
wherein said tab extends outwardly from one of said two opposite side portions, and is adapted to be engaged by a user to manipulate said main body from a closed horizontal position to an open vertical position and vice versa without having to contact said top surface, said bottom surface, or said outer edge.

9. The method of making of claim 8, wherein said tab includes:
a top surface;
a bottom surface;
an outer edge including:
a front section;
a back section; and
two opposite side portions respectively located between said front portion and said back portion;
wherein said back section of said tab is formed with said one of said two opposite side portions; and
wherein said top surface, said bottom surface, said front section, and said two opposite side portions of said tab are adapted to be engaged by a user to manipulate said main body from a closed horizontal position to an open vertical position and vice versa without having to contact said top surface, said bottom surface, or said outer edge.

10. The method of making of claim 9, wherein said top surface and said bottom surface are formed having a curve cross-section adapted to increase friction between the tab and a user and reduce the chance of the seat slipping from the user and slamming upon a toilet bowl.

11. The method of making of claim 9, wherein said front section and said two opposite side portions of said tab include a lip extending downwardly therefrom adapted to increase friction between the tab and a user and reduce the chance of the seat slipping from the user and slamming upon a toilet bowl.

12. The method of making of claim 9, wherein said front section and said two opposite side portions of said tab include a plurality of spaced serrations extending downwardly therefrom adapted to increase friction between the tab and a user and reduce the chance of the seat slipping from the user and slamming upon a toilet bowl.

13. The method of making of claim 8, wherein said main body and said opening are formed having an oval shape.

14. The method of making of claim 8, further comprising the step of:
injection molding a cover including:
a top surface;
a bottom surface;
an outer edge including:
a front section;
a back section; and
two opposite side portions respectively located between said front portion and said back portion;
wherein said back section is pivotally connected to said back section of said outer edge of said main body via said hinge; and
wherein said outer edge has a size and shape substantially equal to said outer edge of said main body, such that said cover is adapted to substantially and removably cover said top surface of said main body.
